(19) United States
(12) Patent Application Publication
(10) Pub. No.: US 2025/0071694 A1
(43) Pub. Date: Feb. 27, 2025

(54) REFERENCE POWER HEADROOM REPORTS AND PATHLOSS MEASUREMENT FOR A UNIFIED TRANSMISSION CONTROL INDICATOR (TCI) FRAMEWORK

(71) Applicant: Apple Inc., Cupertino, CA (US)

(72) Inventors: Yushu ZHANG, Beijing (CN); Dawei ZHANG, Saratoga, CA (US); Haitong SUN, Cupertino, CA (US); Hong HE, San Jose, CA (US); Huaning NIU, San Jose, CA (US); Oghenekome OTERI, San Diego, CA (US); Wei ZENG, Saratoga, CA (US)

(21) Appl. No.: 18/726,700

(22) PCT Filed: Jan. 4, 2022
(86) PCT No.: PCT/CN2022/070100

§ 371 Date: Jul. 3, 2024

(51) Int. Cl. H04W 52/36; H04L 5/00; H04W 52/24

(52) U.S. Cl. CPC H04W 52/365; H04L 5/0048; H04W 52/242

(57) ABSTRACT

A user equipment (UE) includes a set of one or more transceivers and a processor. The processor is configured to receive, from a base station and via the set of one or more transceivers, a set of one or more unified transmission control indicator (TCI) states. The processor is also configured to determine a set of power control parameters for a reference power headroom report (PHR), and to transmit the reference PHR to the base station via the set of one or more transceivers. The set of power control parameters includes a pathloss for a pathloss reference signal (PL-RS) associated with a unified TCI state of the set of one or more unified TCI states.

### CROSS-REFERENCE TO RELATED APPLICATION

This application is a 35 U.S.C. §371 application of PCT/CN2022/070100, filed on Jan. 4, 2022, and entitled “Reference Power Headroom Reports and Pathloss Measurement For a Unified Transmission Control Indicator (TCI) Framework,” which is incorporated herein by reference as if fully disclosed herein.

### TECHNICAL FIELD

This application relates generally to wireless communication systems, including methods and implementations of transmitting reference power headroom reports (PHRs) and/or measuring pathloss for a unified transmission control indicator (TCI) framework.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication network including a base station and a UE.

FIG. 2 shows an example method of a UE, which method may be used to transmit a beam-specific reference PHR to a base station.

FIG. 3 shows a first example medium access control (MAC) control element (CE) (or portion of a MAC CE) that may be used to transmit one or multiple PHRs.

FIG. 4 shows a second example MAC CE (or portion of a MAC CE) that may be used to transmit one or multiple PHRs.

FIG. 5 shows a third example MAC CE (or portion of a MAC CE) that may be used to transmit a single PHR.

FIG. 6 shows an example timeline for activating a set of one or more unified TCI states.

FIG. 7 shows an example method of a base station, which method may be used to reduce the activation delay for a set of one or more (e.g., N) unified TCI states.

FIG. 8 shows another example timeline for activating a set of one or more unified TCI states.

FIG. 9 shows an example method of a UE, which method may be used to reduce the activation delay for a set of one or more (e.g., N) unified TCI states.

FIG. 10 shows an example method of a base station, which method may be used to reduce the activation delay for a set of one or more (e.g., N) unified TCI states.

FIG. 11 shows an example method of a UE, which method may be used to reduce the activation delay for a set of one or more (e.g., N) unified TCI states.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

A power headroom (PH) measurement is defined in the 3GPP technical specifications (i.e., for 4G, 5G, and other types of communication). PH is defined as the gap between a maximum transmission power and an actual transmission power. PH is used to facilitate uplink (UL) resource allocation and scheduling. For example, a base station (e.g., a gNB) can identify the potential UL quality for a UE and schedule reasonable frequency resources for the UE to use (e.g., if the PH for a UE is lower, the UE may not be able to transmit a wideband UL transmission).

Two types of power headroom report (PHR) have been supported since 3GPP Release 15 (Rel-15). See, e.g., Section 7.7 of 3GPP Technical Specification (TS) 38.213. The two types of PHR are a Type 1 PHR and a Type 2 PHR. A Type 1 PHR includes PH measurements based on a set of power control parameters for physical uplink shared channel (PUSCH) transmission. A Type 3 PHR includes PH measurements based on a set of power control parameters for sounding reference signal (SRS) transmission.

For each type of PHR, a UE may report a PH based on an actual transmission (in an actual PHR) or a reference transmission (in a reference PHR). If there is an actual PUSCH/SRS transmission, an actual PHR is transmitted; otherwise, a reference PHR is transmitted. The reference PHR may be derived using a set of predefined power control parameters. For example, PH for a Type 1 reference PHR is calculated as follows:

$$P {H}_{type 1 , b , f , c} ( i , j , {q}_{d} , l ) = {\tilde{P}}_{CMAX , f , c} ( i ) - \{ {P}_{{O}_{PUSCH} , b , f , c} ( j ) + {α}_{b , f , c} ( j ) \cdot {PL}_{b , f , c} ( {q}_{d} ) + {f}_{b , f , c} ( i , l ) \} [ dB ]$$

where P0 and alpha are selected based on the parameters configured for P0-PUSCH-AlphaSetId=0, the pathloss reference signal (PL-RS) used to determine the pathloss (PL) is selected based on the first PL-RS configured (e.g., in radio resource control (RRC) signaling) with pusch-PathlossReference-Id=0, and the closed-loop power control factor (f) is selected based on the first power control loop (l=0).

Pathloss is derived as a higher-layer filtered reference signal receiving power (RSRP) (or L3-RSRP) less a downlink (DL) transmit power for the PL-RS.

In 3GPP Rel-17, a unified TCI framework is being introduced. In accord with such a unified TCI framework, a base station (e.g., a gNB) can indicate, to a UE, a unified TCI state that provides an antenna port quasi-co-location (QCL) indication (e.g., a beam indication) for dedicated physical downlink control channel (PDCCH)/physical downlink shared channel (PDSCH)/PUSCH/physical uplink control channel (PUCCH) transmissions. To support L1/L2 centric inter-cell mobility, the source reference signal for the unified TCI state can be a reference signal (RS, e.g., a synchronization signal block (SSB) or channel state information reference signal (CSI-RS)) transmitted by a UE's serving cell or a neighbor cell.

In 3GPP Rel-17, a base station can optionally configure a set of power control parameters (e.g., P0, alpha, and a closed-loop power control factor) and associate them with an UL or joint unified TCI State. An UL unified TCI state can be used to provide a beam indication for UL channels. A joint unified TCI state can be used to provide a beam indication for both DL and UL channels. If the power control parameters are not provided, default power control parameters can be applied. Also in Rel-17, a base station shall configure a PL-RS associated with one UL or joint unified TCI State.

In Rel-17, a base station can indicate a unified TCI state for all PUSCH/PUCCH, and some SRS resources or SRS resource sets, in a MAC CE or downlink control information (DCI). Whether the SRS resource(s) or SRS resource set(s) share the indicated unified TCI state can be configured by RRC signaling.

In 3GPP Rel-18, a base station may indicate N unified TCI states for UL channels and/or signals. Each unified TCI state may be applied to a set of UL channels. For example, a first unified TCI state may be applied to some PUSCH/PUCCH, and a second unified TCI state may be applied to other PUSCH/PUCCH. The N unified TCI states may be configured by the base station or by a use case. For example, in a multiple transmission and reception point (Multi-TRP) use case, a first unified TCI state may be applied to a first TRP, and a second unified TCI state may be applied to a second TRP.

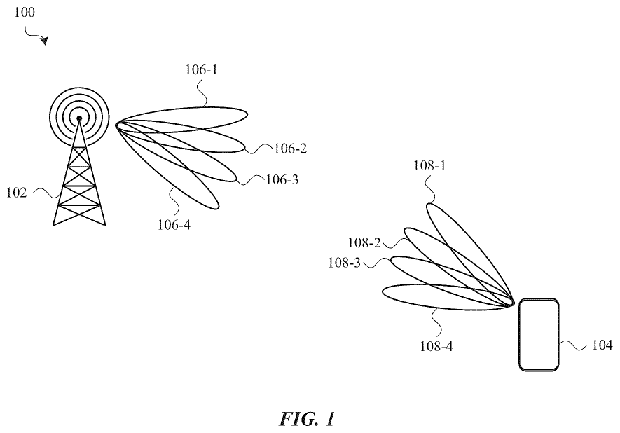

An issue that exists for the unified TCI framework is that a reference PHR is not a meaningful PHR. It is not meaningful because it is always tied to a single, default PL-RS, and therefore only pertains to a single, default beam. Within a unified TCI framework, a reference PHR is needed for a beam indicated by a unified TCI state, which beam may not be the beam associated with the default PL-RS. For example, FIG. 1 shows an example wireless communication network 100 including a base station 102 and a UE 104. The base station 102 may be capable of transmitting or receiving on one or more of multiple beams 106-1, 106-2, 106-3, 106-4. Similarly, the UE 104 may be capable of transmitting or receiving on one or more of multiple beams 108-1, 108-2, 108-3, 108-4. Under the current reference PHR framework, a reference PHR may be derived for a default beam pair (e.g., a first beam pair including beams 106-1 and 108-1), but a unified TCI state may indicate that UL and/or DL transmissions will occur over a different beam pair (e.g., a second beam pair including beams 106-3 and 108-2). A reference PHR for the second beam pair would be useful.

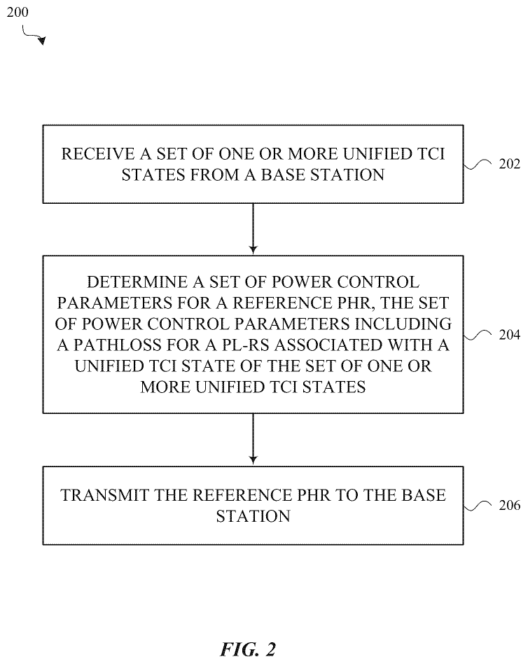

FIG. 2 shows an example method 200 of a UE, which method 200 may be used to transmit a beam-specific reference PHR to a base station.

At 202, the method 200 may include receiving a set of one or more unified TCI states from a base station. The unified TCI states may indicate a set of one or more beams on which the UE should receive a transmission from the base station (in a downlink (DL) direction) and/or transmit to the base station (in an uplink (UL) direction) when receiving and/or transmitting various channels (e.g., PDCCH/PDSCH, PUCCH/PUSCH, and so on) or reference signals (e.g., one or more sounding reference signals (SRSs), channel state information reference signals (CSI-RSs), and so on). The set of one or more unified TCI states may be received, for example, in a MAC CE or DCI.

At 204, the method 200 may include determining a set of power control parameters for a reference PHR. The set of power control parameters may include a pathloss for a PL-RS associated with a unified TCI state of the set of one or more unified TCI states (instead of a default PL-RS).

At 206, the method 200 may include transmitting the reference PHR to the base station. In some embodiments, the reference PHR may be transmitted in a MAC CE.

The set of power control parameters determined at 204 may include various other power control parameters. In some embodiments, the method 200 may be performed for a Type 1 reference PHR. In some of these embodiments, the set of power control parameters (other than pathloss) may include at least one a default power control parameter, such as a default P0 and alpha indicated by P0-PUSCH-AlphSetId=0, a default closed-loop power control factor based on a first power control loop (l=0), and/or other default power control parameters. In some of these embodiments, the set of one or more power control parameters may include at least one power control parameter associated with the unified TCI state with which the PL-RS is associated (and for which the pathloss is determined at 204), such as a P0, alpha, and/or closed-loop power control factor associated with the unified TCI state with which the PL-RS is associated.

In some embodiments, the method 200 may be performed for a Type 3 reference PHR. In some of these embodiments, the set of power control parameters (other than pathloss) may include at least one power control parameter configured for an SRS resource set (e.g., for a first SRS resource set). In some of these embodiments, the set of one or more power control parameters may include at least one power control parameter associated with the unified TCI state with which the PL-RS is associated (and for which the pathloss is determined at 204), such as a P0, alpha, and/or closed-loop power control factor associated with the unified TCI state with which the PL-RS is associated. In some of these embodiments, the method 200 may include determining whether an SRS resource set in a CC or active BWP shares the unified TCI state with which the PL-RS is associated (and for which the pathloss is determined at 204). When no SRS resource set in the CC or active BWP shares the unified TCI state, the set of power control parameters may include at least one power control parameter configured for an SRS resource set (e.g., for a first SRS resource set), but when an SRS resource set in the CC or active BWP shares the unified TCI state, the set of one or more power control parameters may include at least one power control parameter associated with the unified TCI state.

In some embodiments of the method 200, the UE may receive RRC signaling from the base station, and the RRC signaling may enable the UE's transmission of the reference PHR report (e.g., a Type 1 reference PHR or a Type 3 reference PHR).

In some cases, the set of one or more unified TCI states received at 202 may include only one unified TCI state. In other cases, the set of one or more unified TCI states may include multiple unified TCI states (e.g., N unified TCI states, where N>1). In the case of multiple unified TCI states, the UE may transmit one or multiple reference PHRs. In some cases, each of the one or multiple PHRs may be based on a set of power control parameters, as previously described in the context of a single reference PHR.

In the case of multiple unified TCI states, the UE that performs the method 200 may in some cases transmit only a single reference PHR (e.g., one Type 1 reference PHR or one Type 3 reference PHR). The unified TCI state for which the set of power control parameters is determined, and for which the reference PHR is transmitted, may be the unified TCI state having the lowest ID or, alternatively, the unified TCI state having the highest ID. Alternatively, the method 200 may include receiving, from the base station, an indication of the unified TCI state for which the set of power control parameters is determined (and for which the reference PHR is transmitted). The indication may be received, for example, in RRC signaling, a MAC CE, or DCI. Alternatively, the unified TCI state for which the set of power control parameters is determined, and for which the reference PHR is transmitted, may be a first-indicated unified TCI state among the multiple unified TCI states (or another predetermined unified TCI state among the multiple unified TCI states). Alternatively, the method 200 may include selecting the unified TCI state for which the set of power control parameters is determined, and for which the reference PHR is transmitted, based on a PHR trigger condition. In these cases, the reference PHR may include a TCI index that indicates the selected unified TCI state. In some cases, the PHR trigger condition may be associated with a predetermined unified TCI state. In some cases, the same or different PHR trigger condition(s) may be associated with different unified TCI states. In some cases, the PHR trigger condition may be a change in pathloss exceeding a threshold (e.g., one or more of a threshold difference, a threshold percentage, a predetermined fixed threshold, and so on).

In the case of multiple unified TCI states (i.e., N>1), the UE that performs the method 200 may in some cases transmit multiple (X) reference PHRs (e.g., multiple Type 1 reference PHRs, multiple Type 3 reference PHRs, or a combination thereof), where X≤N. The upper bound of N may be reported to the base station in a UE capability report and/or configured by the base station and indicated to the UE in RRC signaling. In these embodiments, the unified TCI state for which the set of power control parameters is determined, and for which the reference PHR is transmitted, may be one unified TCI state of the multiple unified TCI states, and the method 200 may include determining at least one additional set of power control parameters for at least one additional reference PHR, and transmitting the at least one additional reference PHR to the base station. The at least one additional reference PHR may be associated with at least one additional unified TCI state of the multiple unified TCI states (e.g., with each additional reference PHR being associated with a different unified TCI state).

In the case of multiple reference PHR transmissions, the method 200 may in some cases include receiving, from the base station, an indication of a set of unified TCI states, of the multiple unified TCI states, for which to generate the reference PHR and the at least one additional reference PHR. Alternatively, the method 200 may include selecting a set of unified TCI states, from among the multiple unified TCI states, for which to generate the reference PHR and the at least one additional reference PHR, and reporting the set of unified TCI states to the base station. Alternatively, the set of unified TCI states may be selected based on a set of one or more PHR trigger conditions. For example, the UE may transmit a reference PHR for a TCI state when (or after) a prohibit timer (e.g., phr-ProhibitTimer) expires and a measured pathloss for a PL-RS associated with a unified TCI state of the set of one or more unified TCI states has changed more than a power factor (e.g., phr-Tx-PowerFactorChange dB).

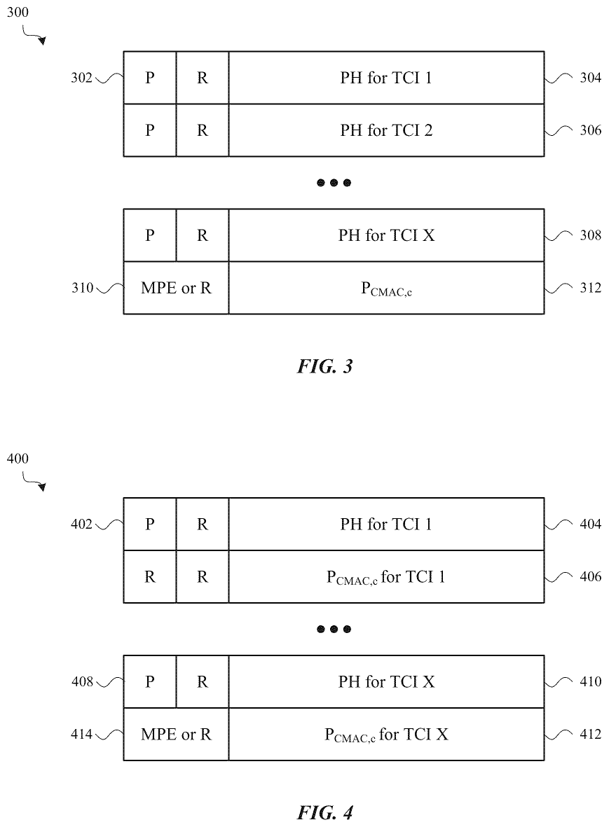

FIG. 3 shows a first example MAC CE 300 (or portion of a MAC CE 300) that may be used to transmit one or multiple PHs. The MAC CE 300 may include fields 302 containing an indication, P, which indicates whether a PH in the MAC CE 300 is an actual PH or a reference PH. The MAC CE 300 may include additional fields 304, 306, 308 containing PHs for each of a set of unified TCI states, including a field 304 containing a PH for unified TCI state 1 (i.e., PH for TCI 1), a field 306 containing a PH for unified TCI state 2 (i.e., PH for TCI 2), and so on, up to a field 308 containing a PH for unified TCI state X (where X≤N). The MAC CE 300 may also include a field 310 for indicating a maximum permitted exposure (MPE), and a field 312 for indicating a configured maximum UE output power for serving cell c (P_{CMAX,c}). Fields marked with an R may be reserved for other purposes.

FIG. 4 shows a second example MAC CE 400 (or portion of a MAC CE 400) that may be used to transmit one or multiple PHs. The MAC CE 400 may include a field 402 containing an indication, P, which indicates whether a particular PH is an actual PH or a reference PH. The MAC CE 400 may also include a field 404 containing a PH for a unified TCI state 1 (i.e., PH for TCI 1), and a field 406 for indicating a configured maximum UE output power for serving cell c (P_{CMAX,c}) for TCI state 1 (i.e., P_{CMAX,c} for TCI 1). The fields 402, 404, and 406 may be replicated (but separately filled) for each of unified TCI states 1 to X (where X≤N). For example, the fields 402, 404, 406 may be replicated as fields 408, 410, 412, and so on. The MAC CE 400 may also include a field 414 for indicating an MPE.

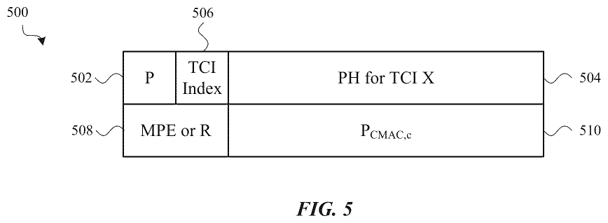

FIG. 5 shows a third example MAC CE 500 (or portion of a MAC CE 500) that may be used to transmit a single PH. The MAC CE 500 may include a field 502 containing an indication, P, which indicates whether the PH is an actual PH or a reference PH. The MAC CE 500 may also include a field 504 containing a PH for a unified TCI state (i.e., PH), a field 506 indicating a TCI index for the unified TCI state, a field 508 for indicating an MPE, and a field 510 for indicating a configured maximum UE output power for serving cell c (P_{CMAX,c}).

After performing a beam failure recovery (BFR) (i.e., after X symbols after the UE receives a PDCCH-based BFR response), a previously indicated unified TCI state may be invalid and the UE may apply a newly identified beam (i.e., a new beam based on a reported SSB/CSI-RS) for transmitting PUCCH and PUSCH. The newly identified beam may also be applied for one or more SRSs that shared the previously indicated unified TCI state. For determining a pathloss, a PL-RS may be based on the reported SSB/CSI-RS, and a default P0, alpha, and closed-loop power control factor may be applied.

After performing the BFR, the UE may determine a new set of power control parameters for a new reference PHR. Some or all of the new set of power control parameters may be based on the power control parameters used for transmission of PUCCH/PUSCH/SRS on the newly identified beam. In some cases, the new set of power control parameters may include a pathloss for a PL-RS associated with the reported SSB/CSI-RS for the new beam, and a P0, alpha, and closed-loop power control factor used for transmitting the PUSCH and SRS.

Because pathloss is derived from higher-layer filtered RSRP measurements, the pathloss reference signal activation delay for a set of one or more (e.g., N) unified TCI states can be longer than desired. For example, a set of one or more unified TCI states can be indicated in a MAC CE or DCI, which in theory can enable the one or more unified TCI states to be updated with very low latency. However, because activation of a unified TCI state is based on a determined pathloss, which pathloss is in turn based on multiple measurements of a PL-RS and a higher-layer filtered RSRP, measurement of the PL-RSs increases the activation delay for a unified TCI state (and often increases the activation delay significantly).

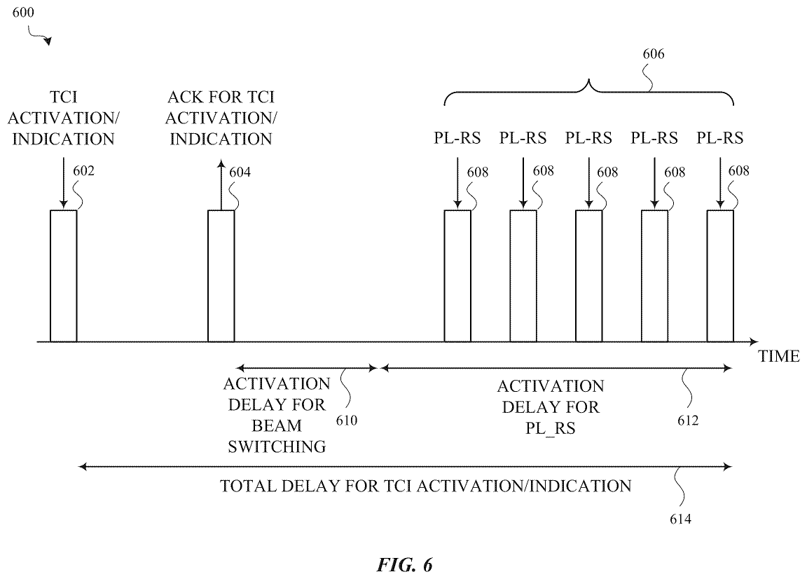

FIG. 6 shows an example timeline 600 in which TCI activation/indication signaling may be transmitted by a base station, to a UE, at 602 (at one or more times, and in one or more types of signaling). At 604, the UE may transmit, to the base station, an acknowledgement (ACK) of the TCI activation/indication signaling. At 606, a set of PL-RSs 608 (e.g., K PL-RSs) may be transmitted by the base station, to the UE, for a unified TCI state in the set of one or more unified TCI states. In some cases, and by way of example, K may be 5 (e.g., K=5). The PL-RSs 608 for a unified TCI state should be transmitted from the same antenna port. Additional and different PL-RSs may also be transmitted for additional and different unified TCI states.

Following an optional activation delay 610 for beam switching, which delay 610 may be incurred following the UE's acknowledgement of the TCI activation/indication signaling, an additional activation delay 612 related to measurement of the PL-RSs by the UE may be incurred. After a sum of the delays (i.e., after a total delay 614), the base station and UE may begin transmitting/receiving on a set of one or more beams indicated by the set of one of more unified TCI states.

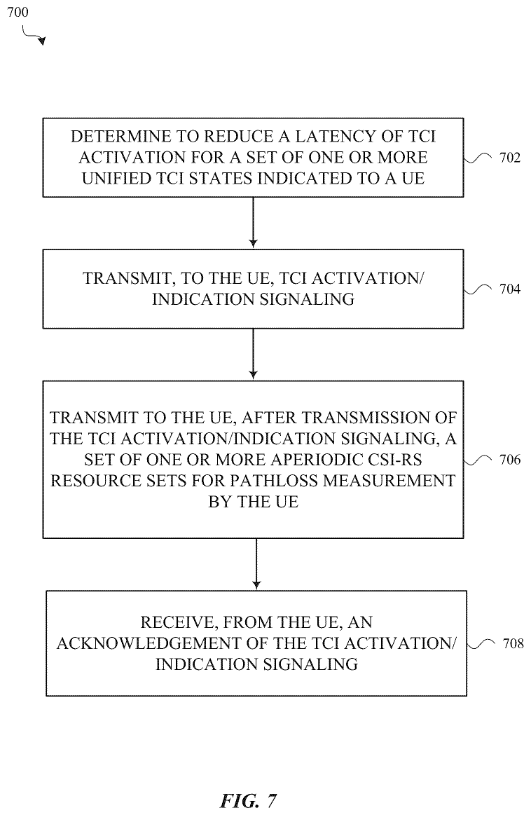

FIG. 7 shows an example method 700 of a base station, which method 700 may be used to reduce the activation delay for a set of one or more (e.g., N) unified TCI states.

At 702, the method 700 may optionally include determining to reduce a latency of TCI activation for a set of one or more unified TCI states indicated to a UE.

At 704, the method 700 may include transmitting, to the UE, TCI activation/indication signaling.

At 706, the method 700 may include transmitting (or triggering) to the UE, after transmission of the TCI activation/indication signaling, a set of one or more aperiodic CSI-RS resource sets for pathloss measurement by the UE. Each aperiodic CSI-RS resource set in the set of one or more aperiodic CSI-RS resource sets may correspond to a respective unified TCI state in the set of one or more unified TCI states, and may be transmitted from a same antenna port as a PL-RS for the respective unified TCI state. If there are N unified TCI states in the set of one or more unified TCI states, N aperiodic CSI-RS resource sets may be transmitted (or triggered).

At 708, the method 700 may include receiving, from the UE, an acknowledgement of the TCI activation/indication signaling.

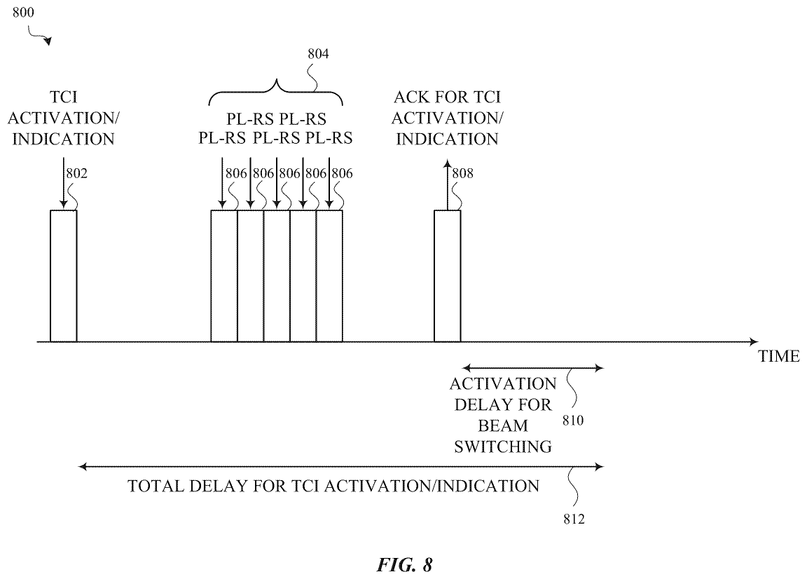

An example timeline 800 of the signaling performed at 704, 706, and 708 is shown in FIG. 8. In the timeline 800, TCI activation/indication signaling may be transmitted by a base station, to a UE, at 802 (at one or more times, and in one or more types of signaling). At 804, an aperiodic CSI-RS resource set including a number of CSI-RS resources 806 (e.g., K CSI-RS resource sets) may be transmitted by the base station, to the UE, for a unified TCI state in the set of one or more unified TCI states. In some cases, and by way of example, K may be 5 (e.g., K=5). The CSI-RS resources 806 within a CSI-RS resource set should be transmitted from the same antenna port (e.g., repetition may be set to ‘on’ for each CSI-RS resource set). Additional and different aperiodic CSI-RS resource sets may also be transmitted between 802 and 808 for additional and different unified TCI states. The CSI-RS resources 806 for each CSI-RS resource set should be quasi-co-located (QCLed) with or transmitted from the same antenna port as the PL-RS for an indicated unified TCI state. At 808, the UE may transmit, to the base station, an acknowledgement of the TCI activation/indication signaling.

Following an optional activation delay 810 for beam switching, which delay 810 may be incurred following the UE's acknowledgement (ACK) of the TCI activation/indication signaling, the base station and UE may begin transmitting/receiving on a set of one or more beams indicated by the set of one of more unified TCI states. In the timeline 800, the total delay 812 for TCI activation/indication is reduced in comparison to the total delay for TCI activation/indication shown in FIG. 6.

In some embodiments, the method 700 may include triggering the set of one or more aperiodic CSI-RS resource sets to the UE in DCI, and indicating the set of one or more aperiodic CSI-RS resource sets is for pathloss measurement in RRC signaling (e.g., in an RRC parameter) provided for the UE. For example, an RRC parameter (pathlossEstimation) may be configured for an aperiodic CSI-RS resource set, to indicate that the CSI-RS resource set is used for pathloss estimation.

In some embodiments, the method 700 may include triggering the set of one or more aperiodic CSI-RS resource sets to the UE in the TCI activation/indication signaling (e.g., N CSI-RS resource sets may be triggered by N unified TCI states, in a MAC CE or in a DCI-based TCI update), at 704.

The CSI-RS resources included in a CSI-RS resource set provided for pathloss measurement may be transmitted within a time-frequency resource slot or, alternatively, across slots. The slot offset may be configured per CSI-RS resource (for across slot transmission) or per CSI-RS resource set (for within slot transmission).

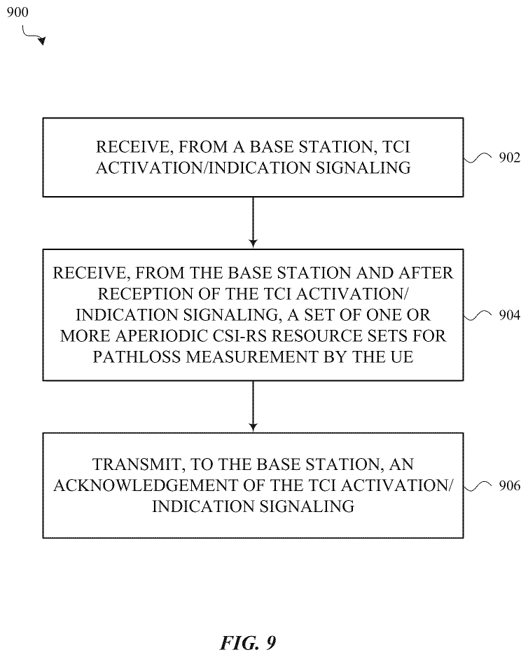

FIG. 9 shows an example method 900 of a UE, which method 900 may be used to reduce the activation delay for a set of one or more (e.g., N) unified TCI states.

At 902, the method 900 may include receiving, from a base station, TCI activation/indication signaling.

At 904, the method 900 may include receiving, from the base station and after reception of the TCI activation/indication signaling, a set of one or more aperiodic CSI-RS resource sets for pathloss measurement by the UE. Each aperiodic CSI-RS resource set in the set of one or more aperiodic CSI-RS resource sets may correspond to a respective unified TCI state in the set of one or more unified TCI states, and may be received from a same antenna port as a PL-RS for the respective unified TCI state. If there are N unified TCI states in the set of one or more unified TCI states, N aperiodic CSI-RS resource sets may be received.

At 906, the method 900 may include transmitting, to the base station, an acknowledgement of the TCI activation/indication signaling.

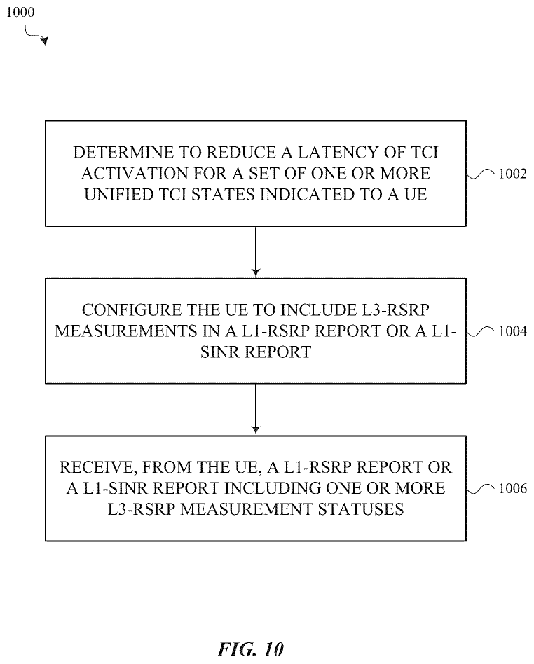

FIG. 10 shows an example method 1000 of a base station, which method 1000 may be used to reduce the activation delay for a set of one or more (e.g., N) unified TCI states.

At 1002, the method 1000 may optionally include determining to reduce a latency of TCI activation for a set of one or more unified TCI states indicated to a UE.

At 1004, the method 1000 may include configuring the UE to include Layer 3 reference signal received power (L3-RSRP) measurements in a Layer 1 RSRP (L1-RSRP) report or a L1 signal-to-interference ratio (L1-SINR) report. Because TCI indication should be based on a normal beam report (e.g., a L1-RSRP or L1-SINR report), it may be possible, in some cases, for a UE to perform L3-RSRP measurements for the beams at the same time. It can be assumed, for example, that L3-RSRP measurements for a beam included in a L1-RSRP or L1-SINR report, performed with X milliseconds (ms), can be derived by a UE. X may be predefined, or reported in a UE capability report, or configured by the base station. In some cases, the base station may be configured the UE in RRC signaling, which may be configured per BWP/CC or per CSI-reportConfig. In some cases, the UE may report to the base station (e.g., in a UE capability report) whether it supports L3-RSRP measurements in a L1-RSRP or L1-SINR report. The UE may also or alternatively report a maximum number of beams for which it can perform and report L3-RSRP measurements in a L1-RSRP or L1-SINR report.

At 1006, the method 1000 may include receiving, from the UE, a L1-RSRP report or a L1-SINR report including one or more L3-RSRP measurement statuses.

If the PL-RS associated with an indicated unified TCI state is already included in a L1-RSRP or L1-SINR beam report (i.e., if L3-RSRP for the beam is maintained), no additional activation delay for PL-RS update is needed.

As an extension, because the number of beams for which L3-RSRP measurement can be made and reported by the UE in a L1-RSRP or L1-SINR report may be limited, the UE may indicate whether L3-RSRP measurement for a particular beam is maintained or not. For example, an L1-RSRP or L1-SINR report may include an additional bit (e.g., a L3-RSRP measurement status bit), for each reported SSB resource indicator (SSBRI) or CSI-RS resource indicator (CRI), to indicate whether a L3-RSRP measurement for the SSB/CSI-RS is maintained or not.

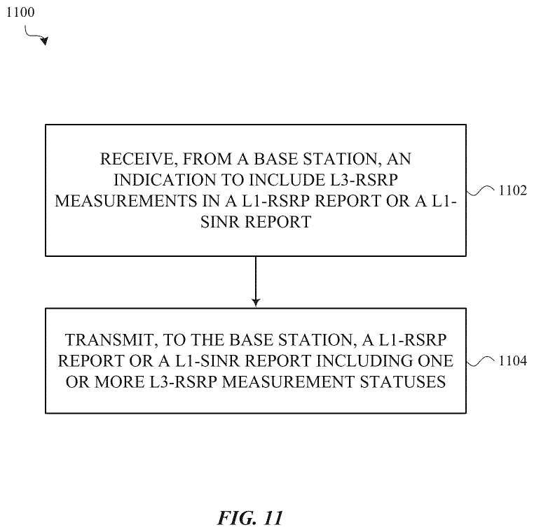

FIG. 11 shows an example method 1100 of a UE, which method 1100 may be used to reduce the activation delay for a set of one or more (e.g., N) unified TCI states.

At 1102, the method 1100 may include receiving, from a base station, an indication to include L3-RSRP measurements in a L1-RSRP report or a L1-SINR report. In some cases, the indication may be received in RRC signaling, which may be configured per BWP/CC or per CSI-reportConfig. In some cases, the method may include reporting to the base station (e.g., in a UE capability report) whether the UE supports L3-RSRP measurements in a L1-RSRP or L1-SINR report. The UE may also or alternatively report a maximum number of beams for which it can perform and report L3-RSRP measurements in a L1-RSRP or L1-SINR report.

At 1104, the method 1100 may include transmitting, to the base station, a L1-RSRP report or a L1-SINR report including one or more L3-RSRP measurement statuses.

Embodiments contemplated herein include an apparatus having means to perform one or more elements of the method 200, 700, 900, 1000, or 1100. In the context of method 200, 900, or 1100, the apparatus may be, for example, an apparatus of a UE (such as a wireless device 1302 that is a UE, as described herein). In the context of method 700 or 1000, the apparatus may be, for example, an apparatus of a base station (such as a network device 1320 that is a base station, as described herein).

Embodiments contemplated herein include one or more non-transitory computer-readable media storing instructions to cause an electronic device, upon execution of the instructions by one or more processors of the electronic device, to perform one or more elements of the method 200, 700, 900, 1000, or 1100. In the context of method 200, 900 or 1100, the non-transitory computer-readable media may be, for example, a memory of a UE (such as a memory 1306 of a wireless device 1302 that is a UE, as described herein). In the context of method 700 or 1000, the non-transitory computer-readable media may be, for example, a memory of a base station (such as a memory 1324 of a network device 1320 that is a base station, as described herein).

Embodiments contemplated herein include an apparatus having logic, modules, or circuitry to perform one or more elements of the method 200, 700, 900, 1000, or 1100. In the context of method 200, 900, or 1100, the apparatus may be, for example, an apparatus of a UE (such as a wireless device 1302 that is a UE, as described herein). In the context of method 700 or 1000, the apparatus may be, for example, an apparatus of a base station (such as a network device 1320 that is a base station, as described herein).

Embodiments contemplated herein include an apparatus having one or more processors and one or more computer-readable media, using or storing instructions that, when executed by the one or more processors, cause the one or more processors to perform one or more elements of the method 200, 700, 900, 1000, or 1100. In the context of method 200, 900, or 1100, the apparatus may be, for example, an apparatus of a UE (such as a wireless device 1302 that is a UE, as described herein). In the context of the method 700 or 1000, the apparatus may be, for example, an apparatus of a base station (such as a network device 1320 that is a base station, as described herein).

Embodiments contemplated herein include a signal as described in or related to one or more elements of the method 200, 700, 900, 1000, or 1100.

Embodiments contemplated herein include a computer program or computer program product having instructions, wherein execution of the program by a processor causes the processor to carry out one or more elements of the method 200, 700, 900, 1000, or 1100. In the context of method 200, 900, or 1100, the processor may be a processor of a UE (such as a processor(s) 1304 of a wireless device 1302 that is a UE, as described herein), and the instructions may be, for example, located in the processor and/or on a memory of the UE (such as a memory 1306 of a wireless device 1302 that is a UE, as described herein). In the context of method 700 or 1000, the processor may be a processor of a base station (such as a processor(s) 1322 of a network device 1320 that is a base station, as described herein), and the instructions may be, for example, located in the processor and/or on a memory of the base station (such as a memory 1324 of a network device 1320 that is a base station, as described herein).

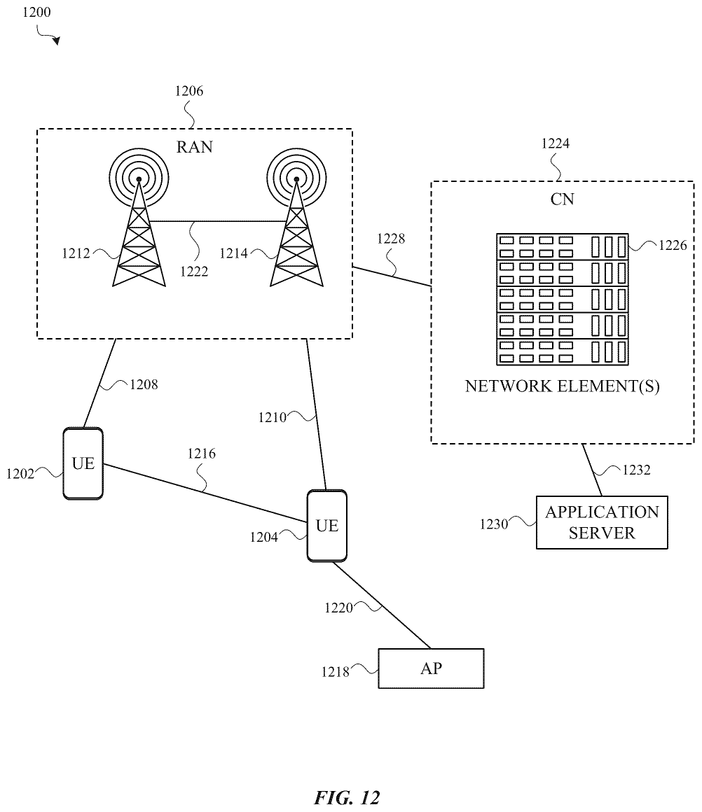

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations, such as base station 1212 and base station 1214, that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VOIP sessions, group communication sessions, etc.) for the UE 1202 and UE 1204 via the CN 1224. The application server 1230 may communicate with the CN 1224 through an IP communications interface 1232.

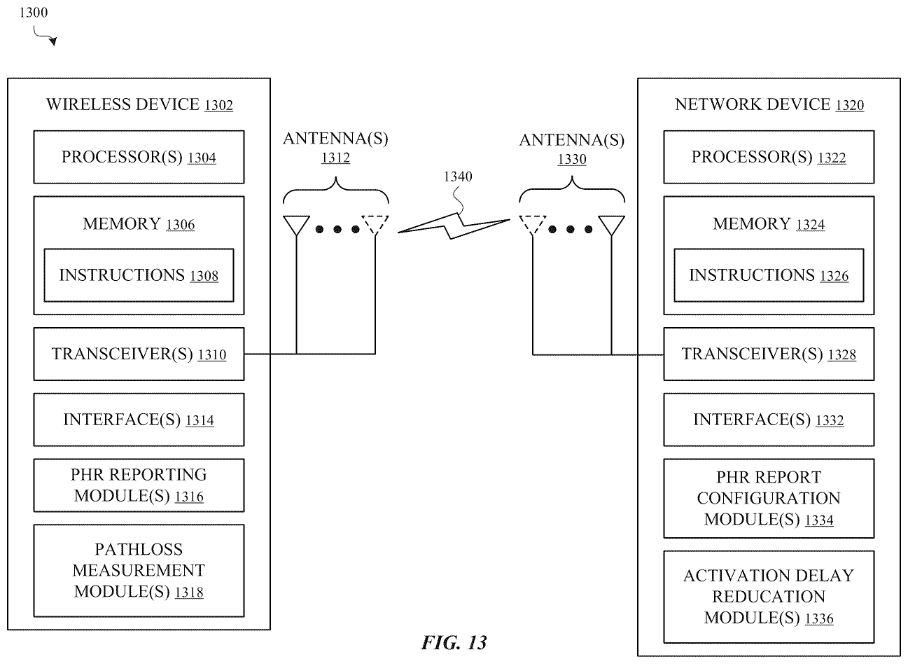

FIG. 13 illustrates a system 1300 for performing signaling 1340 between a wireless device 1302 and a network device 1320, according to embodiments disclosed herein. The system 1300 may be a portion of a wireless communication system as herein described. The wireless device 1302 may be, for example, a UE of a wireless communication system. The network device 1320 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1340) to and/or from the wireless device 1302 with other devices (e.g., the network device 1320) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include one or more PHR reporting modules 1316 and/or pathloss measurement modules 1318. The PHR reporting module(s) 1316 and pathloss measurement module(s) 1318 may be implemented via hardware, software, or combinations thereof. For example, the PHR reporting module(s) 1316 and pathloss measurement module(s) 1318 may be implemented as a processor, circuit, and/or instructions 1308 stored in the memory 1306 and executed by the processor(s) 1304. In some examples, the PHR reporting module(s) 1316 and pathloss measurement module(s) 1318 may be integrated within the processor(s) 1304 and/or the transceiver(s) 1310. For example, the PHR reporting module(s) 1316 and pathloss measurement module(s) 1318 may be implemented by a combination of software components (e.g., executed by a DSP or a general processor) and hardware components (e.g., logic gates and circuitry) within the processor(s) 1304 or the transceiver(s) 1310.

The PHR reporting module(s) 1316 may be used for various aspects of the present disclosure, for example, aspects of FIGS. 1-6. The PHR reporting module(s) 1316 may be configured to, for example, determine a set of power control parameters and transmit a PHR to another device (e.g., the network device 1320).

The pathloss measurement module(s) 1318 may be used for various aspects of the present disclosure, for example, aspects of FIGS. 7-11. The pathloss measurement module(s) 1318 may be configured to, for example, reduce a pathloss signal-related activation delay for activating one or more unified TCI states, as described herein.

The network device 1320 may include one or more processor(s) 1322. The processor(s) 1322 may execute instructions such that various operations of the network device 1320 are performed, as described herein. The processor(s) 1304 may include one or more baseband processors implemented using, for example, a CPU, a DSP, an ASIC, a controller, an FPGA device, another hardware device, a firmware device, or any combination thereof configured to perform the operations described herein.

The network device 1320 may include a memory 1324. The memory 1324 may be a non-transitory computer-readable storage medium that stores instructions 1326 (which may include, for example, the instructions being executed by the processor(s) 1322). The instructions 1326 may also be referred to as program code or a computer program. The memory 1324 may also store data used by, and results computed by, the processor(s) 1322.

The network device 1320 may include one or more transceiver(s) 1328 that may include RF transmitter and/or receiver circuitry that use the antenna(s) 1330 of the network device 1320 to facilitate signaling (e.g., the signaling 1340) to and/or from the network device 1320 with other devices (e.g., the wireless device 1302) according to corresponding RATs.

The network device 1320 may include one or more antenna(s) 1330 (e.g., one, two, four, or more). In embodiments having multiple antenna(s) 1330, the network device 1320 may perform MIMO, digital beamforming, analog beamforming, beam steering, etc., as has been described.

The network device 1320 may include one or more interface(s) 1332. The interface(s) 1332 may be used to provide input to or output from the network device 1320. For example, a network device 1320 that is a base station may include interface(s) 1332 made up of transmitters, receivers, and other circuitry (e.g., other than the transceiver(s) 1328/antenna(s) 1330 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1320 may include one or more PHR report configuration modules 1334 and/or one or more activation delay reduction modules 1336. The PHR report configuration module(s) 1334 and activation delay reduction module(s) 1336 may be implemented via hardware, software, or combinations thereof. For example, the PHR report configuration module(s) 1334 and activation delay reduction module(s) 1336 may be implemented as a processor, circuit, and/or instructions 1326 stored in the memory 1324 and executed by the processor(s) 1322. In some examples, the PHR report configuration module(s) 1334 and activation delay reduction module(s) 1336 may be integrated within the processor(s) 1322 and/or the transceiver(s) 1328. For example, the PHR report configuration module(s) 1334 and activation delay reduction module(s) 1336 may be implemented by a combination of software components (e.g., executed by a DSP or a general processor) and hardware components (e.g., logic gates and circuitry) within the processor(s) 1322 or the transceiver(s) 1328.

The PHR report configuration module(s) 1334 may be used for various aspects of the present disclosure, for example, aspects of FIGS. 1-6. The PHR report configuration module(s) 1334 may be configured to, for example, configure PHR reports that are to be transmitted by another device (e.g., the wireless device 1302).

The activation delay reduction module(s) 1336 may be used for various aspects of the present disclosure, for example, aspects of FIGS. 7-11. The activation delay reduction module(s) 1336 may be configured to, for example, configure another device (e.g., the wireless device 1302) to reduce a pathloss signal-related activation delay for activating one or more unified TCI states.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a set of one or more transceivers; and
a processor configured to,
receive, from a base station and via the set of one or more transceivers, a set of one or more unified transmission control indicator (TCI) states;
determine a set of power control parameters for a reference power headroom report (PHR), the set of power control parameters including a pathloss for a pathloss reference signal (PL-RS) associated with a unified TCI state of the set of one or more unified TCI states; and
transmit the reference PHR to the base station via the set of one or more transceivers.

2. The UE of claim 1, wherein:
the reference PHR is a Type 1 reference PHR; and
the set of power control parameters includes,
a default P0 and alpha indicated by P0-PUSCH-AlphSetId=0; and
a default closed-loop power control factor based on a first power control loop.

3. The UE of claim 1, wherein the set of power control parameters includes a P0, alpha, and closed-loop power control factor associated with the unified TCI state of the set of one or more unified TCI states.

4. The UE of claim 1, wherein:
the reference PHR is a Type 3 reference PHR; and
the set of power control parameters includes at least one power control parameter configured for a first sounding reference signal (SRS) resource set.

5. The UE of claim 1, wherein:
the reference PHR is a Type 3 reference PHR;
the processor is configured to determine whether a sounding reference signal (SRS) resource set in a component carrier (CC) or active bandwidth part (BWP) shares the unified TCI state;
when no SRS resource set in the CC or BWP shares the unified TCI state, the set of power control parameters includes at least one power control parameter configured for a first SRS resource set; and
when an SRS resource set in the CC or active BWP shares the unified TCI state, the set of power control parameters includes a P0, alpha, and closed-loop power control factor associated with the unified TCI state.

6. The UE of claim 1, wherein the reference PHR is a Type 1 reference PHR or a Type 3reference PHR.

7. The UE of claim 1, wherein the processor is configured to receive, from the base station and via the set of one or more transceivers, radio resource control (RRC) signaling enabling the reference PHR.

8. The UE of claim 1, wherein:
the set of one or more unified TCI states includes multiple unified TCI states; and
the unified TCI state with which the PL-RS is associated has a lowest identifier (ID) or a highest ID among the multiple unified TCI states.

9. The UE of claim 1, wherein:
the set of one or more unified TCI states includes multiple unified TCI states; and
the processor is configured to receive, from the base station and via the set of one or more transceivers, an indication of the unified TCI state with which the PL-RS is associated.

10. The UE of claim 1, wherein:
the set of one or more unified TCI states includes multiple unified TCI states; and
the unified TCI state with which the PL-RS is associated is a first-indicated unified TCI state among the multiple unified TCI states.

11. The UE of claim 1, wherein:
the set of one or more unified TCI states includes multiple unified TCI states;
the processor is configured to select the unified TCI state with which the PL-RS is associated based on a PHR trigger condition; and
the reference PHR includes a TCI index indicating the unified TCI state with which the PL-RS is associated.

12. The UE of claim 1, wherein:
the set of one or more unified TCI states includes multiple unified TCI states;
the unified TCI state with which the PL-RS is associated is one unified TCI state of the multiple unified TCI states; and
the processor is configured to,
determine at least one additional set of power control parameters for at least one additional reference PHR, the at least one additional reference PHR associated with at least one additional unified TCI state of the multiple unified TCI states; and
transmit the at least one additional reference PHR to the base station via the set of one or more transceivers.

13. The UE of claim 12, wherein the processor is configured to receive, from the base station and via the set of one or more transceivers, an indication of a set of unified TCI states, of the multiple unified TCI states, for which to generate the reference PHR and the at least one additional reference PHR.

14. The UE of claim 12, wherein:
the processor is configured to,
select a set of unified TCI states, from among the multiple unified TCI states, for which to generate the reference PHR and the at least one additional reference PHR; and
report the set of unified TCI states to the base station via the set of one or more transceivers.

15. The UE of claim 14, wherein the set of unified TCI states is selected based on a set of one or more PHR trigger conditions.

16. The UE of claim 1, wherein:
the processor is configured to,
perform a beam failure recovery (BFR);
identify, after performing the BFR, a new beam for transmitting a physical uplink shared channel (PUSCH); and
determine, after identifying the new beam, a new set of power control parameters for a new reference PHR, the new set of power control parameters including,
a new pathloss for a new PL-RS associated with a reported synchronization signal block (SSB)/channel state information reference signal (CSI-RS) for the new beam; and
a P0, alpha, and closed-loop power control factor used for transmitting the PUSCH.

17. A base station, comprising:
a set of one or more transceivers; and
a processor configured to,
determine to reduce a latency of transmission control indicator (TCI) activation for a set of one or more unified TCI states indicated to a user equipment (UE);
transmit, via the set of one or more transceivers and to the UE, TCI activation/indication signaling;
transmit, via the set of one or more transceivers and to the UE, after transmission of the TCI activation/indication signaling, a set of one or more aperiodic channel state information reference signal (CSI-RS) resource sets for pathloss measurement by the UE, each aperiodic CSI-RS resource set in the set of one or more aperiodic CSI-RS resource sets corresponding to a respective unified TCI state in the set of one or more unified TCI states and being transmitted from a same antenna port as a pathloss reference signal (PL-RS) for the respective unified TCI state; and
receive, via the set of one or more transceivers and from the UE, an acknowledgement of the TCI activation/indication signaling.

18. The base station of claim 17, wherein:
the processor is configured to,
trigger the set of one or more aperiodic CSI-RS resource sets to the UE in downlink control information (DCI); and
indicate the set of one or more aperiodic CSI-RS resource sets is for pathloss measurement in radio resource control (RRC) signaling provided for the UE.

19. The base station of claim 17, wherein the processor is configured to trigger the set of one or more aperiodic CSI-RS resource sets to the UE in the TCI activation/indication signaling.

20. A base station, comprising:
a set of one or more transceivers; and
a processor configured to,
determine to reduce a latency of transmission control indicator (TCI) activation for a set of one or more unified TCI states indicated to a user equipment (UE);
configure the UE to include Layer 3 reference signal received power (L3-RSRP) measurements in a Layer 1 RSRP (L1-RSRP) report or an L1 signal-to-interference ratio (L1-SINR) report; and
receive, via the set of one or more transceivers and from the UE, the L1-RSRP report or the L1-SINR report including one or more L3-RSRP measurement statuses.
